(19) United States
(12) Patent Application Publication
(10) Pub. No.: US 2011/0248476 A1
(43) Pub. Date: Oct. 13, 2011

(54) WHEEL SUSPENSION

(76) Inventor: Torbjorn Ericsson, Fengersfors (SE)

(21) Appl. No.: 13/140,103

(22) PCT Filed: Dec. 8, 2008
(86) PCT No.: PCT/SE09/51390

§ 371 Date: Jun. 28, 2011

(30) Foreign Application Priority Data
Dec. 17, 2008 (SE) 0850148-8

(51) Int. Cl. B62D 49/08; B60B 27/00

(52) U.S. Cl. 280/638; 301/105.1

(57) ABSTRACT

A wheel suspension for mounting in a chassis of a working machine, said wheel suspension comprising a drive axle, a wheel and a hub device, said hub device comprising a first hub unit, which is stationary in the axial direction of the wheel suspension and connected to said axle, and a second hub unit, which is connected to the wheel, said second hub unit being adapted to be displaced in the axial direction of the wheel suspension relative to the first hub unit for altering the axial position of the wheel relative to the first hub unit, wherein the hub device also comprises an actuator for controlled actuation of the second hub unit to bring about said displacement. According to the invention, the actuator comprises a hydraulic cylinder (51), which is arranged inside a protecting and supporting means (52) for absorbing forces or force components in the radial direction of the hydraulic cylinder, said protecting and supporting means comprising a first supporting sleeve (53), which is adapted to be connected to the chassis, and a second supporting sleeve (54), which is directly or indirectly connected to the second hub unit, said supporting sleeves being telescopically arranged within each other for enabling a telescopic movement between the supporting sleeves.

The present invention relates to a wheel suspension for mounting in a chassis (1) of a working machine, said wheel suspension comprising a drive axle, a wheel and a hub device, said hub device comprising a first hub unit, which is stationary in the axial direction of the wheel suspension and connected to said axle, and a second hub unit, which is connected to the wheel, said second hub unit being adapted to be displaced in the axial direction of the wheel suspension relative to the first hub unit for altering the axial position of the wheel relative to the first hub unit, wherein the hub device also comprises an actuator for controlled actuation of the second hub unit to bring about said displacement.

A wheeled working machine, which has an operating arm carrying a load-handling implement at its outer end, is subjected to large loads when the implement is working, especially when the operating arm is extended and the implement is at its largest distance from the working machine itself and carries large loads, which completely or partially clear the ground, or is working in the ground with a great resistance from objects or materials in the ground. Accordingly, the working machine must have sufficient stability on the ground in order not to tip over in a direction towards the implement, even when the implement picks up loads in the periphery of its working area and especially in those parts of the working area which are located at the opposing sides of the working machine, i.e. transversely to the machine direction or in the extensions of the wheel axles. For some working machines, special extendable ground supports are required to achieve the necessary stability of the working machine, but this implies that the ground is sufficiently firm and does not give way under the ground supports. In those cases when no such stability-increasing ground supports are used, or even cannot be used at all, for a given wheel track of the working machine, the size of the working area is determined by the weight of the working machine, in other words, the weight should be sufficient to support occurring high loads on the implement also in the periphery of the prescribed working area. There are also demands for an increased working area from a parked position of the working machines. In order to meet this demand, which means an increased reach of the implement and thereby an increased load on the working machine, the stability of the working machine has to be increased correspondingly, something which, accordingly, should be achieved without resorting to stability-increasing ground supports or making the working machine wider permanently, which would impair the working machine's driveability both on roads as well as off-road.

All of the problems discussed above are present especially in working machines in the form of forest harvesters, which have an extendable crane arm carrying at its outer end a harvester head, having the task of gripping around a standing tree, cutting the tree, and thereafter pivoting down the tree, and holding the tree above the ground in order to carry out delimbing and cutting into logs. Especially when thinning forest, it is desirable to reach further into the thinning stand from a parked position than what has hitherto been possible, in order to, among other things, be able to increase the distance between the strip roads along which the harvester operates. Also during final cutting, however, it is desirable to be able to reduce the number of position changes by being capable of increasing the reach of the harvester in each position.

Working machines with or without implement-carrying operating arms, which are used e.g. in forestry, are relatively heavy and thereby cause great damages to the ground, especially when they are driven on ground with small carrying capacity for the heavy working machines. The damages are aggravated due to the fact that all wheels run in one and the same track on each side of the working machine. One type of working machines causing such ground damages is forwarders, which impose a load on a roadway repeatedly for the transport of timber from a forest stand to a motor road. A harvester can also cause ground damages on forest roadways, or on the side of them.

SE 529 713 describes a wheel suspension for a working machine, said wheel suspension enabling alteration of the track width as required in order to increase the stability of the working machine and/or to distribute the ground load of the working machine over a larger ground area. The wheel suspension comprises an axle and a hub device. The hub device comprises a first hub unit, which is connected to the axle, and a second hub unit, which is connected to a wheel of the wheel suspension. The second hub unit can be displaced axially relative to the first hub unit by means of external actuators in the form of hydraulic cylinders, which are arranged between the first hub unit and the second hub unit and extend in parallel with the axle.

One problem with wheel suspensions of the type disclosed in SE 529 713 is that the external actuators are at risk of being subjected to damaging shocks and loads. This is particularly a problem in harvesters, forwarders and other types of forest machines, where there is a risk of rocks, tree parts and other objects being forced up under the forest machine and hitting the actuators when the forest machine is driven off-road.

One solution to this problem is to arrange the actuators internally, i.e. inside the axle of the wheel suspension. This, however, is a mechanically complicated and thereby expensive solution, which further leads to the problem that the axle occupies a large volume.

Accordingly, there is a need for wheel suspensions of the above-described type where the actuators are so arranged that they are protected from damaging load.

The object of the present invention is to produce such a wheel suspension.

The wheel suspension according to the invention is characterized in that the actuator comprises a hydraulic cylinder, which is arranged inside a protecting and supporting means for absorbing forces or force components in the radial direction of the hydraulic cylinder, said protecting and supporting means comprising a first supporting sleeve, which is adapted to be connected to the chassis, and a second supporting sleeve, which is directly or indirectly connected to the second hub unit, said supporting sleeves being telescopically arranged within each other for enabling a telescopic movement between the supporting sleeves.

In the following, the invention will be described more closely with the aid of a presently preferred embodiment, while referring to the attached drawings.

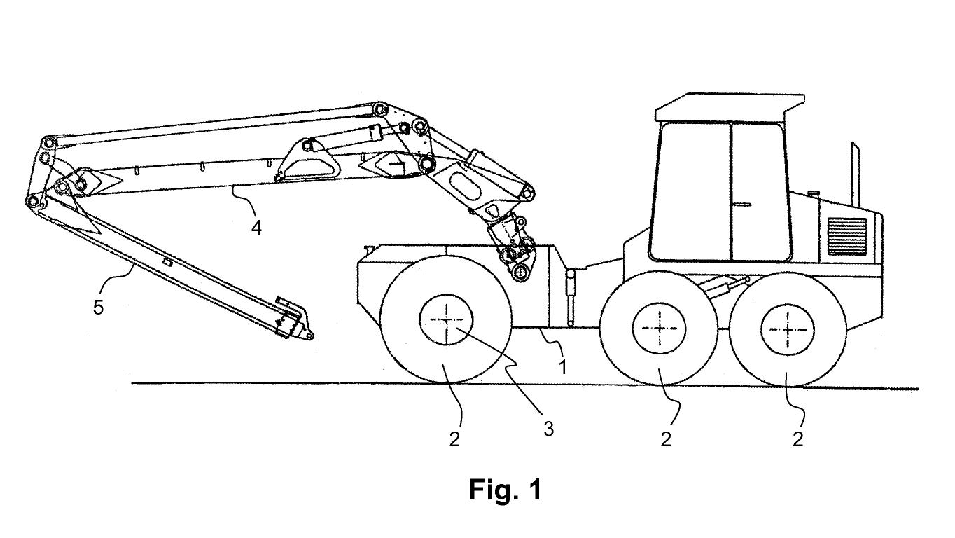

FIG. 1 schematically shows a forest harvester.

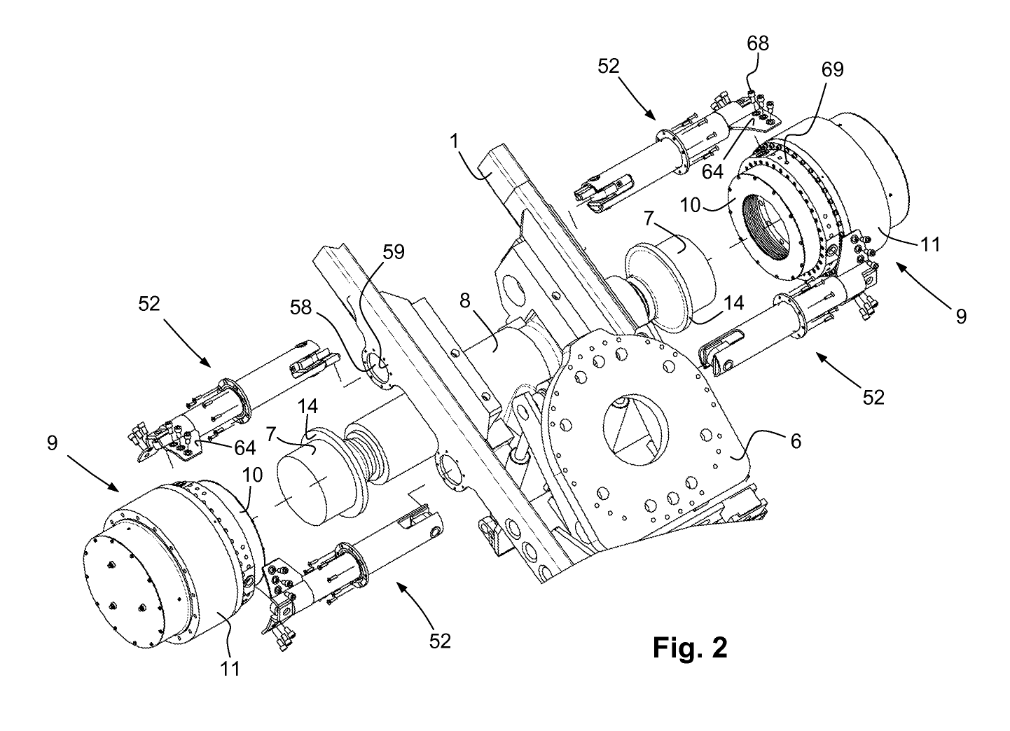

FIG. 2 schematically shows, in an exploded view, a wheel axle assembly with a wheel suspension according to the invention at both of its ends.

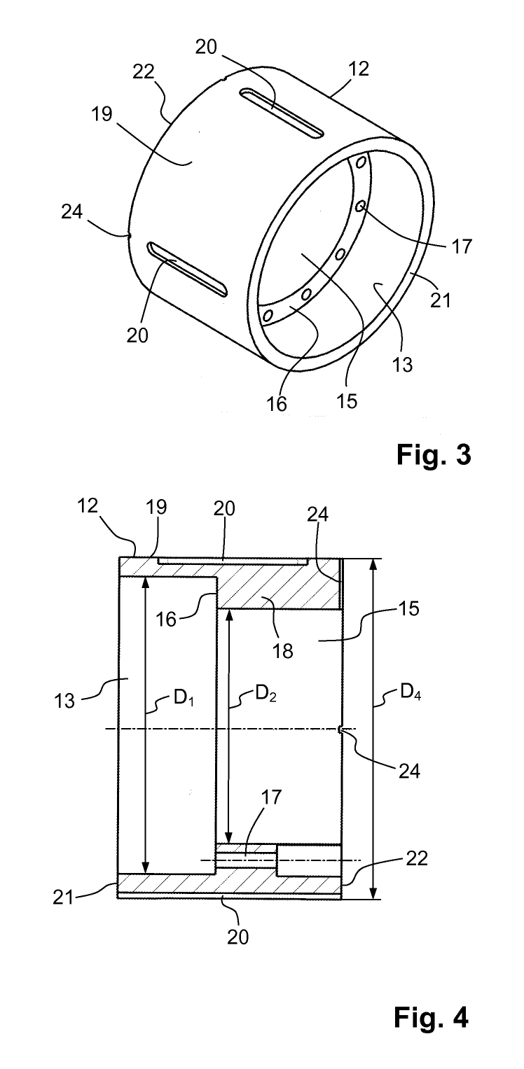

FIG. 3 is a perspective view of a first hub unit in the hub device of the wheel suspension.

FIG. 4 is an axial sectional view of the hub unit of FIG. 3.

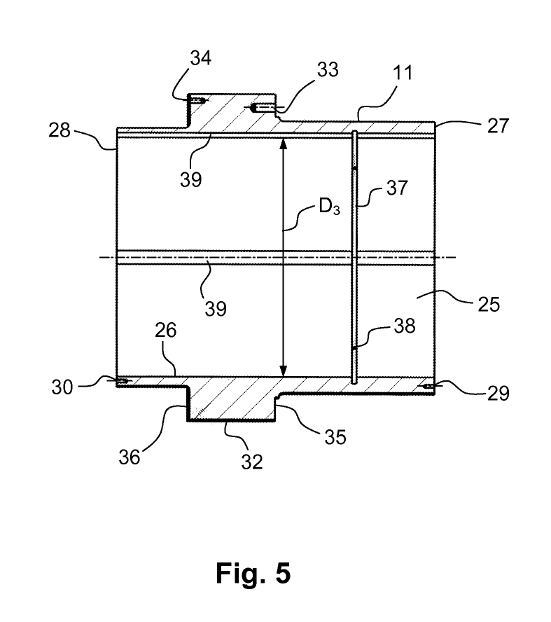

FIG. 5 is an axial sectional view of a second hub unit in the hub device of the wheel suspension.

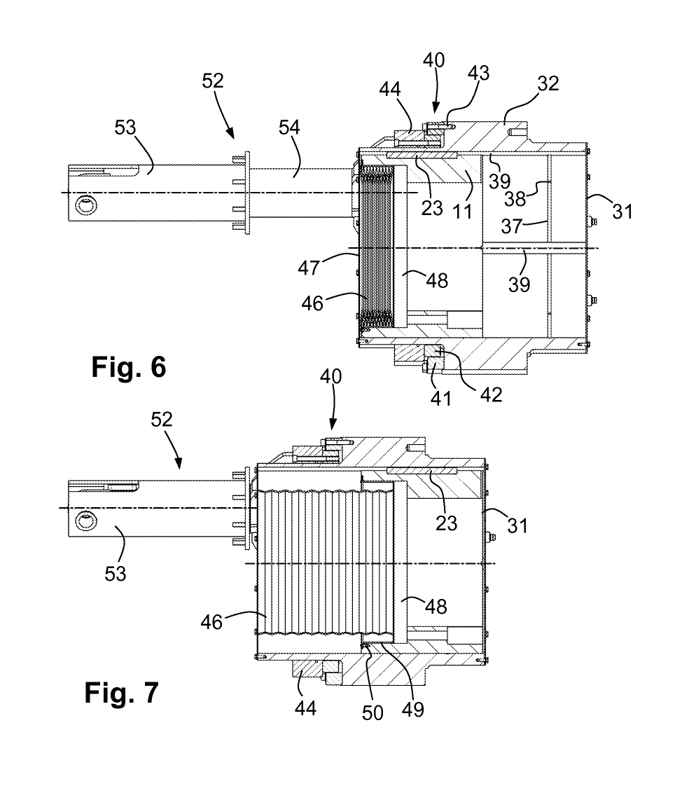

FIG. 6 schematically shows a wheel suspension of FIG. 2 where the second hub unit is in an extended position.

FIG. 7 schematically shows the wheel suspension of FIG. 6 in a retracted position.

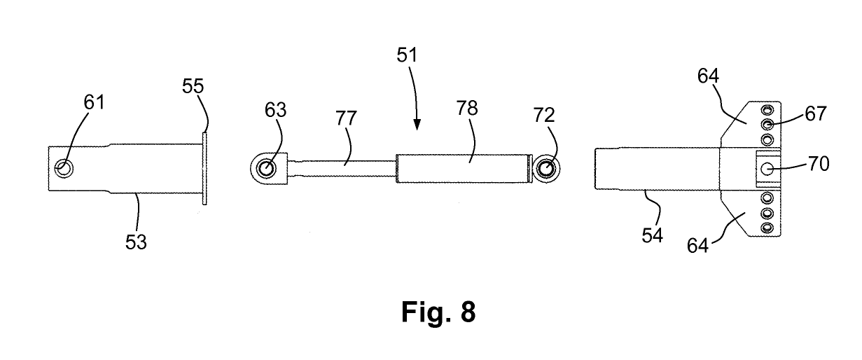

FIG. 8 schematically shows, in an exploded view, a protecting and supporting means according to the invention.

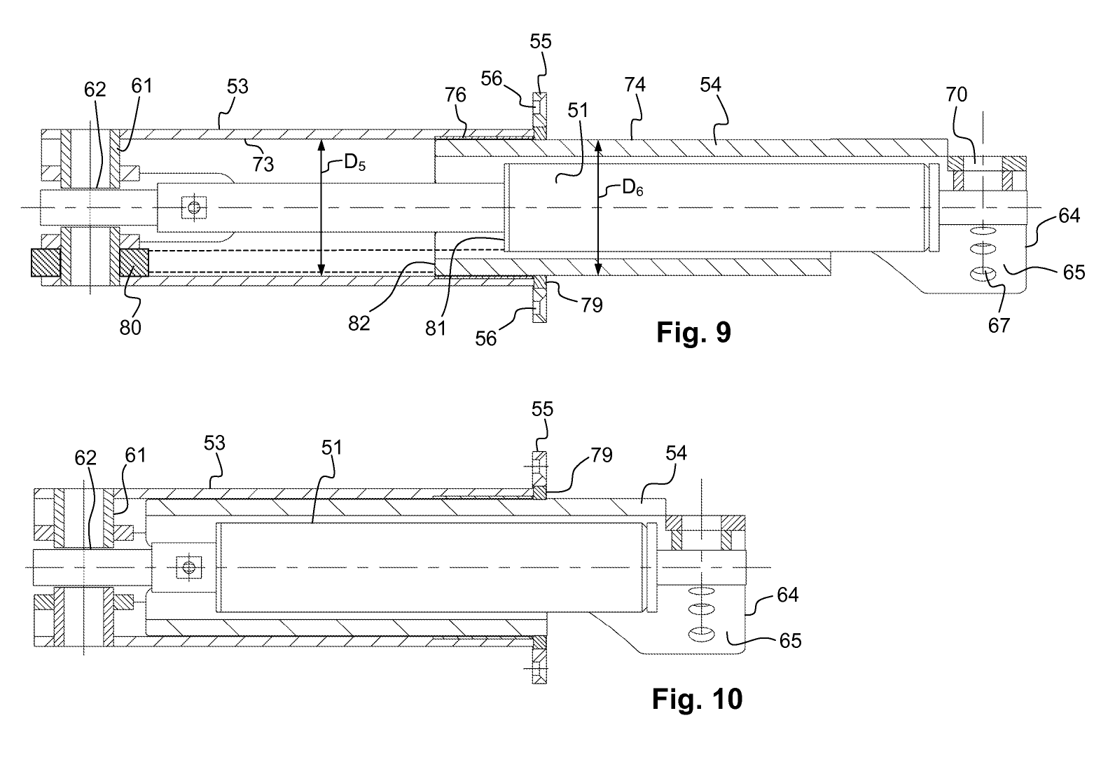

FIG. 9 is an axial sectional view of a protecting and supporting means according to the invention in an extended position.

FIG. 10 is an axial sectional view of the protecting and supporting means of FIG. 9 in a retracted position.

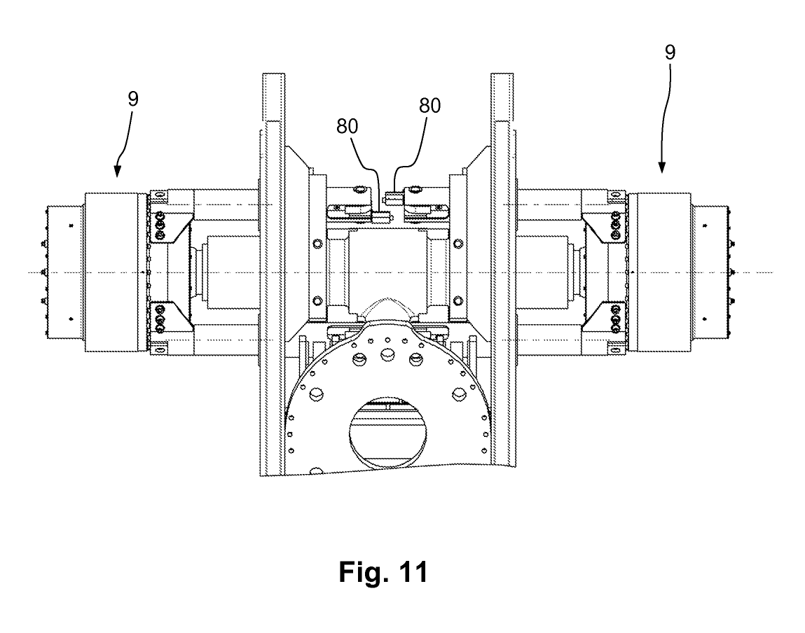

FIG. 11 is a top view of a wheel axle assembly according to FIG. 2.

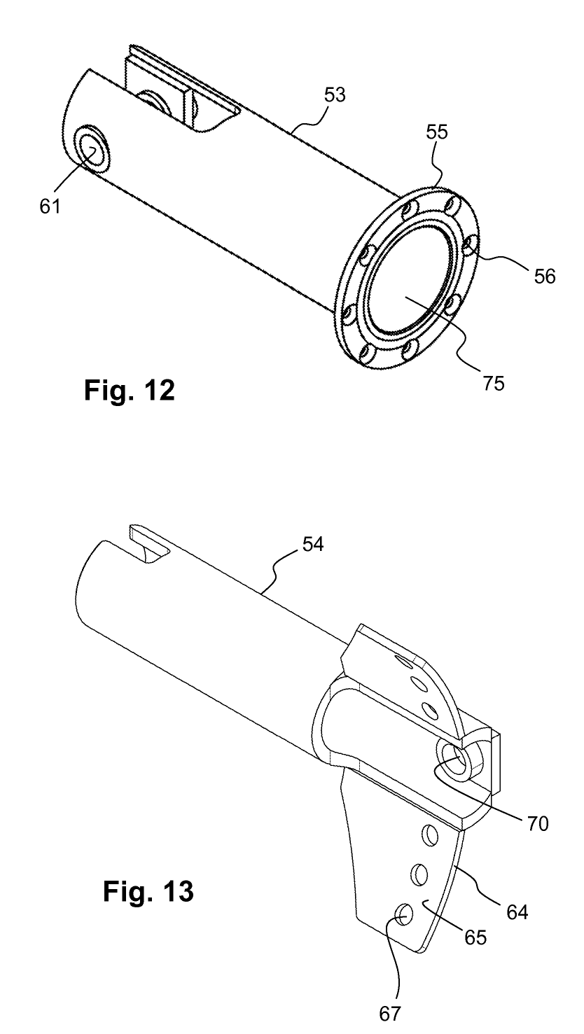

FIG. 12 is a perspective view of a first supporting sleeve of a protecting and supporting means according to the invention.

FIG. 13 is a perspective view of a second supporting sleeve of a protecting and supporting means according to the invention.

FIG. 1 schematically shows a working machine or contract machine in the form of a forest harvester, which has a chassis 1 and front and rear wheel suspensions for wheels 2. The front wheel suspensions are part of a bogie axle assembly, and the rear ones are part of a driving wheel axle assembly 3. A crane arm 4 is pivotally mounted on the chassis 1 and is adapted to carry various types of implements, for example a harvester head (not shown), on its outer pivot arm 5.

FIG. 2 shows an exploded view of the rear portion of the chassis 1 and the wheel axle assembly 3. The chassis comprises a mounting surface 6 for the crane arm 4. The wheel axle assembly 3 comprises two opposing hubs 7, which are driven by a transmission system, comprising drive axles and gears for driving the hubs 7, said transmission system being arranged in a gear housing 8.

The wheel axle assembly 3 further comprises two opposing hub devices 9 of the type described in SE 529 713. Accordingly, each hub device 9 comprises a first, inner hub unit 10, which is attached to the hub 7, and a second, outer hub unit 11, which carries the wheels of the wheel suspension. A combined locking and guiding device carries out the double function of locking the two hub units 10, 11 to each other in the circumferential direction for their common rotation, and of allowing axial displacement, by controlled force actuation, of the outer hub unit 11 and its wheel 2 relative to the inner wheel unit 10, in order to alter the distance between the wheels 2 of the wheel axle assembly 3 in the desired way.

Advantageously, said hub units and locking and guiding device can be of the known types described in SE 529 713, and which shortly will be described in the following. It is appreciated, however, that other hub units and locking and guiding devices can be used within the scope of the invention.

The inner hub unit 10 comprises a supporting element 12, which has the shape of a hollow cylindrical sleeve (see FIGS. 3 and 4). The supporting element 12 has a first, inner space 13, having a diameter D₁ which is adapted to a mounting flange 14 of the hub 7, so that the mounting flange 14 can be received in the first space 13 with a good fit, i.e. without detrimental play and without frictional engagement. Furthermore, the supporting element 12 has a second, outer space 15, having a diameter D₂ which is adapted to the cylindrical shape of the hub 7, so that the hub 7 can be received in the second space 15 with a good fit, i.e. without detrimental play and without frictional engagement, wherein the axial length of the hub 7 is equal to or slightly smaller than the axial length of the outer space 15. The two spaces 13, 15 merge into each other. It is appreciated that half of the difference between the two diameters D₁ and D₂ corresponds to the radial extension of the mounting flange 14, plus/minus occurring tolerances. At the transition between the two spaces 13, 15, a radial support surface 16 is formed, against which surface the radial mounting flange 14 is to abut. A plurality of axial through holes 17 are arranged in the thicker wall portion 18 of the supporting element 12 for passing through bolts (not shown), which are screwed into opposing threaded holes in the mounting flange 14, after the supporting element 12 has been displaced coaxially relative to the hub 7 in order to enclose the same and until the inner, radial support surface 16 meets the mounting flange 14, which serves as a stop. The above-mentioned bolts produce a stable screw joint between the supporting element 12 and the hub 7, so that a stable rotatable unit is formed. The supporting element 12 has an external, rotationally cylindrical surface 19, in which four axial grooves 20 are arranged. The grooves 20 are uniformly distributed in the circumferential direction and have their ends located at a distance from the opposing, inner and outer, end surfaces 21, 22 of the supporting element 12. The grooves 20 serve as seats for corresponding wedges 23 (see FIGS. 6 and 7), projecting radially outward a predetermined distance from the grooves 20. Furthermore, there are radial, diametrically opposing grooves 24 in the outer end surface 22 of the supporting element 12, said grooves 24 allowing passage of lubricant in a direction from outside.

The above-mentioned second, outer hub unit 11 (see FIG. 5) also has the shape of a hollow cylindrical sleeve, and is adapted to enclose the entire first, inner hub unit 10. The expressions “inner” and “outer” are used to indicate the radial positions of the hub units 10, 11 relative to each other. The outer hub unit 11 has a through-going, cylindrical, unitary space 25 for receiving and enclosing the inner hub unit 10, as is evident from FIGS. 6 and 7. The cylindrical space 25, which thus has the same diameter D₃ all the way through, is delimited by a rotationally symmetrical, internal surface 26 of the wall of the hub unit 11. The inside diameter D₃ of the hub unit 11, i.e. of the space 25, is slightly larger than the outside diameter D₄ (see FIG. 4) of the inner hub unit 10, so that a small gap of a predetermined size is formed between their cylindrical surfaces 19, 26. The size of the gap should be as small as possible to reduce angular misalignment between the surfaces 19, 26 and wear of these surfaces. The gap size is suitably between 0.05 and 0.5 mm. It is preferably in the lower part of the interval, and most preferably it is 0.05-0.1 mm. The outer hub unit 11 has a planar, outer end surface 27, and a planar, inner end surface 28. Both end surfaces 27, 28 are provided with axial, threaded holes 29, 30. The outer end surface 27 is tightly sealed by a cover 31 (see FIGS. 6 and 7), which is secured by screwing to the hub unit 11 by means of bolts in said threaded holes 29 thereof, while using a suitable sealing device therebetween, e.g. a sealing ring. An axially wide and radially thick mounting flange 32 is formed on the outside of the outer hub unit 11. As is evident from the following description of the mounting of the hub device, the mounting flange 32 is arranged on the other half of the hub unit 11, which is located closest to the wheel of the hub unit 11 and at a distance from the inner end surface 28 of the hub unit 11. The mounting flange 32 is sufficiently wide, i.e. has a sufficient axial extension, in order to leave place for axial, threaded holes 33, 34 in both directions. The mounting flange 32 exhibits two radial annular surfaces 35, 36, from which said threaded holes 33, 34 extend. The wheel of the hub unit 11 is secured by screwing to the hub unit 11 by means of bolts, which are passed through the holes in the rim flange of the wheel and are screwed into the threaded holes 33 of the mounting flange 32.

An annular groove 37 is formed in the internal surface 26 of the wall of the hub unit 11, and a plurality of radial apertures 38 extend through the wall and open into the groove 37 for entry of lubricant, which fills the groove 37 and the gap between the two hub units 10, 11, when the inner hub unit 10 is inserted into the outer hub unit 11.

Furthermore, four axial, parallel guide grooves 39 are formed in the internal surface 26 of the wall of the hub unit 11, said guide grooves 39 extending continuously between the end surfaces 27, 28. The guide grooves 39 are uniformly distributed in the circumferential direction and are adapted to the dimensions of the projecting or free portions of the wedges 23, so that the wedges 23 can move frictionlessly in the grooves. The wedges 23 and the guide grooves 39 constitute an advantageous embodiment of said combined locking and guiding device. Accordingly, the wedges 23 and the guide grooves 39 have the double function of locking the two hub units 10, 11 to each other in the circumferential direction for their common rotation, on the one hand, and of allowing axial displacement, by controlled force actuation, of the outer hub unit 11 relative to the inner hub unit 10, on the other hand, in order to alter the distance between the wheels of the wheel axle assembly 3, or another axle assembly such as a bogie axle assembly or non-driven axle assembly with rotatably mounted hubs, in the desired way.

On its outside, the outer hub unit 11 carries a ball bearing ring 40 (see FIGS. 6 and 7), which thus encloses the hub unit 11. The ball bearing ring 40 is located adjacent to the mounting flange 32 and comprises an outer ring member 41 and an inner ring member 42, which are rotatable relative to each other about an intermediate ball bearing (not shown). The outer ring member 41 is provided with a plurality of axial through holes for bolts 43, by means of which the ball bearing ring 40 is fixed by screwing to the mounting flange 32 via its outer ring member 41, whereas the inner ring member 42, accordingly, has no direct contact of its own with the outer hub unit 11, but only an indirect contact via the outer ring member 41.

Furthermore, on its outside, the outer hub unit 15 carries a mounting ring 44, which thus encloses the hub unit 11. The mounting ring 44 is located axially outside the ball bearing ring 40 and, with respect to its width, extends all the way to the inner end edge 28 of the outer hub unit 11. The inner ring member 42 of the ball bearing ring 40 is provided with a plurality of threaded axial holes, whereas the mounting ring 44 is provided with a corresponding number of through-going, axial holes for passing through bolts 45, which are secured by screwing to the inner ring member 42 with subsequent fixed attachment of the mounting ring 44 to the inner ring member 42.

The hub device further comprises a sealing device 46, which is adapted to seal the two hub units 10, 11 from the inside. A suitable sealing device is a tubular bellows of a suitable resilient material. The sealing bellows 46 has an outer, annular, radial flange 47 (see FIGS. 6 and 7), which is provided with a plurality of screw holes (not shown), and an inner, annular, radial flange 48, which is designed with an axial collar 49. During the mounting, the sealing bellows 46 is inserted into the first, inner space 13 of the supporting element 10, whereupon the inner flange 48 and its collar 49 are attached to and fixed against the inner end surface 21 of the inner hub device 10 by means of screw joints 50. Thereafter, the outer flange 47 is secured by screwing to the inner end surface 28 of the outer hub unit 11, so that the gap between the two hub units 10, 11, as well as the inner space 13 of the supporting element 12, are sealed.

The hub device comprises an actuator for controlled axial displacement of the outer hub unit 11 relative to the inner hub unit 10, which is thus axially stationary. In the shown embodiment, the actuator is constituted of two double-acting hydraulic cylinders 51 (see FIGS. 8, 9 and 10) for each wheel and hub device.

According to the invention, each hydraulic cylinder 51 is mounted inside a protecting and supporting means 52 (see FIGS. 2, 6 and 7), which is adapted to absorb radial forces. As used herein, radial forces refer to forces or force components acting in a direction transversely to the longitudinal direction of the hydraulic cylinder 51. Such forces can arise e.g. as a result of rocks or tree parts being forced up under the working machine and hitting the wheel axle assembly 3.

Each protecting and supporting means 52 comprises a first, inner, supporting sleeve 53, and a second, outer supporting sleeve 54.

At its outer end, the inner supporting sleeve 53, which is substantially tubular, comprises an external flange 55 (see FIG. 12), extending in the circumferential direction around the outer end of the supporting sleeve 55. The flange 55 exhibits a plurality of axial openings 56 (see FIGS. 9 and 10) being uniformly distributed in the circumferential direction, which openings are adapted to receive bolts 57 for the formation of a screw joint with the chassis 1. For this purpose, the chassis 1 exhibits an opening 58 for receiving the inner supporting sleeve 53, on the one hand, and an outwardly facing support surface 59 for interaction with the flange 55, on the other hand. The support surface 59 exhibits threaded holes 60 for receiving the bolts 57. In a mounted state, the inner supporting sleeve 53 is thus recessed into the chassis 1, as is shown in FIG. 11, so that only the flange 55 projects from the support surface 59. At its inner end, the supporting sleeve 53 exhibits a tube 61, extending transversely to the longitudinal direction of the supporting sleeve and through the supporting sleeve, which tube at its middle portion has an open portion 62 for receiving an inner attachment lug 63 of the hydraulic cylinder 51 (see FIGS. 9 and 10). The hydraulic cylinder is locked to the supporting sleeve 53 by passing a pivot pin (not shown) through the tube 61 and the attachment lug 63.

At its outer end, the outer supporting sleeve 55, which is also substantially tubular, comprises projecting, curved wings 64. The wings 64 have an inside surface 65, which has a radius of curvature corresponding to the radius of curvature of the outside surface 66 of the mounting ring 44. The wings 64 exhibit through openings 67 for receiving bolts 68, and the mounting ring 44 exhibits corresponding threaded holes 69 for reception of the bolts 68 and the formation of a screw joint with the supporting sleeve 55, as is shown in FIG. 11. At its outer end, the supporting sleeve 55 also exhibits an opening 70 for receiving a locking means in the form of a bolt (not shown), said opening extending transversely to the longitudinal direction of the supporting sleeve 55. The mounting ring 44 exhibits a corresponding threaded hole 71 (see FIG. 2) for the formation of a screw joint with said bolt. The hydraulic cylinder 51 comprises an outer attachment lug 72 and is locked to the mounting ring 44 by passing said bolt (not shown) through the opening 70 and the attachment lug 72 and threading it into the threaded hole 71 (see FIGS. 9 and 10).

The inner supporting sleeve 53 has an internal, circularly cylindrical limiting surface 73, having a diameter D₅. The outer supporting sleeve 54 has an external, circularly cylindrical limiting surface 74, having a diameter D₆. At its outer end, the inner supporting sleeve 53 exhibits an opening 75 (see FIG. 12) for receiving the inner end of the outer supporting sleeve 54. The outside diameter D₆ of the outer supporting sleeve 54 is slightly smaller than the inside diameter D₅ of the inner supporting sleeve 53, and the outer supporting sleeve 54 is adapted to move inside the inner supporting sleeve 53 with a good fit, with the hydraulic cylinder 51 arranged axially inside the supporting sleeves 53, 54, as is shown in FIGS. 9 and 10. Accordingly, the supporting sleeves 53, 54 are telescopically arranged within each other, and thus enable a telescopic movement between the supporting sleeves 53, 54 in the longitudinal direction of the hydraulic cylinder 51. At the opening 75, the limiting surface 73 exhibits a recess, into which a cylindrical sliding bushing 76 (see FIGS. 9 and 10) is recessed. Accordingly, the limiting surface 74 of the outer supporting sleeve 54 forms a support surface for interaction with the sliding bushing 76 and/or the limiting surface 73, which thus forms an internal support surface of the inner supporting sleeve 53. Thereby, the sliding bushing 76 preferably has such an extension in the axial direction, that a guiding of the outer supporting sleeve 54 is obtained, so that, in normal conditions, it is centered inside the inner supporting sleeve 53 and allows radial force transmission between the support surfaces 73 and 74 only to a limited extent.

For axial displacement of the outer hub unit 11 relative to the inner hub unit 10, the wheel axle assembly 3 comprises two hydraulic cylinders 51 on each side, each being arranged inside protecting and supporting means 52 in the above-described way. Each hydraulic cylinder 51 is, with its piston rod 77, connected to the chassis 1 via the inner supporting sleeve 53 and, with its piston cylinder 78, to the mounting ring 44 of the outer hub unit 11. When connecting the hydraulic cylinders 51 for extending their piston rods 77, the pressure force will be transferred to the outer hub unit 11 via the attachment lugs 72, the mounting ring 44, the ball bearing ring 40, and the mounting flange 32 of the outer hub unit 11. Since the outer hub unit 11 is not fixed to the inner hub unit 10 in the axial direction, but only in the circumferential direction, the outer hub unit 11, together with its wheel, the rim of which (not shown) is fixedly mounted to the outer hub unit 11, will be displaced in a direction outward relative to the inner hub unit 10. The outward displacement can take place until the inner end surfaces 21, 28 of the two hub units 10, 11 become flush with each other, as is shown in FIG. 6. In order to increase the track width or wheel track of the wheel axle assembly 3 even more, the outer hub unit with wheel of the second, opposing hub device, is displaced in a corresponding way.

Accordingly, the inner supporting sleeve 53 is rigidly connected to the chassis 1 and the outer supporting sleeve 54 is rigidly connected to the mounting ring 44 of the outer hub unit 11. All external forces or force components acting on the supporting sleeves 53 and 54 will thus be transferred to the chassis 1 and the outer hub unit 11, respectively, without imposing any load on the hydraulic cylinder 51 arranged inside the supporting sleeves 53, 54. Furthermore, the design of the protecting and supporting means 52 enables external forces or force components to be distributed between the supporting sleeves 53, 54, since the design allows radial force transmission between the supporting sleeves 53, 54, either via the sliding bushing 76 or directly via the support surfaces 73 and 74. Thus, also in such a situation, no load is imposed on the hydraulic cylinder 51 arranged inside the supporting sleeves 53, 54.

Accordingly, according to the invention, the inner supporting sleeve 53 is directly or indirectly connected to the chassis 1, so that it is stationary in the axial direction of the wheel suspension.

The forest harvester is preferably provided with a lifting device, which is extendably or lowerably mounted in the chassis 1 in the vicinity of the drive axle assembly or another axle assembly with adjustable wheel suspensions, in order to be brought to bear against the ground or support to thereby lift the forest harvester a sufficient distance, so that the wheels of the drive axle assembly clear the ground or the support, whereupon one or both wheels can be displaced axially by connecting the hydraulic cylinders 51. The wheels can also be displaced axially during movement of the forest harvester by simultaneous connection of the hydraulic cylinders 51.

In the foregoing, the invention has been described starting from a specific embodiment. It is appreciated, however, that other embodiments or variants are conceivable within the scope of the invention. For instance, a sealing, for example in the form of an O-ring 79 (see FIGS. 9 and 10), can advantageously be arranged at the opening 75 to prevent contaminants from penetrating in between the support surfaces 73 and 74.

It is also appreciated that the protecting and supporting means 52 according to the invention enables other advantageous designs. A distance sensor, for example a laser sensor 80 (see FIG. 11), can e.g. be placed protected inside one of the supporting sleeves in order to monitor and control the extension movement of the outer hub unit 11. For instance, a laser sensor 80 (see FIGS. 9 and 11) can be fixed inside the inner supporting sleeve 53, at the inner end of the supporting sleeve 53, in order to measure the distance to the inner cylinder surface 81 of the hydraulic cylinder 51 or to the inner end surface 82 (see FIG. 9) of the outer supporting sleeve 54. It is appreciated that the distance sensor alternatively can be placed inside the outer supporting sleeve 11 in order to monitor and control the extension movement by measuring the distance to the inner supporting sleeve 10 directly or indirectly.

The invention can be applied to any working machine, where increased stability and/or increased track width according to the requirements is desired, such as forwarders, but in addition to harvesters as described above, also to regular tractors for e.g. agriculture. The invention can also be applied to machines being pulled by a vehicle, e.g. an agricultural tractor, and which are usually single axled, i.e. have only one axle assembly, where it is desired that the machine being pulled has a different, e.g. larger, track width than the one of the tractor, in order to thus spare the ground.

It is further appreciated that the invention can be applied to working machines which are at least intermittently track-bound, e.g. to working machines for railroad maintenance, which working machines, on the one hand, have conventional, air-filled wheels for transporting the working machine on the road and, on the other hand, extendable railroad wheels, which are suspended according to the invention for quick and easy adjustment of the correct wheel track.

1-9. (canceled)

10. A wheel suspension for mounting in a chassis of a working machine, said wheel suspension comprising:
a drive axle;
a wheel; and
a hub device, said hub device comprising a first hub unit, which is stationary in the axial direction of the wheel suspension and connected to said axle, and a second hub unit, which is connected to a wheel, said second hub unit being adapted to be displaced in the axial direction of the wheel suspension relative to the first hub unit for altering the axial position of the wheel relative to the first hub unit, wherein the hub device also comprises an actuator for controlled actuation of the second hub unit to bring about said displacement, wherein the actuator comprises a hydraulic cylinder, which is arranged inside a protecting and supporting means for absorbing forces or force components in the radial direction of the hydraulic cylinder, said protecting and supporting means comprising a first supporting sleeve, which is adapted to be connected to the chassis, and a second supporting sleeve, which is directly or indirectly connected to the second hub unit, said supporting sleeves being telescopically arranged within each other for enabling a telescopic movement between the supporting sleeves.

11. The wheel suspension according to claim 10, wherein the piston end of the hydraulic cylinder is connected to the first supporting sleeve, and in that the cylinder end of the hydraulic cylinder is connected to the second supporting sleeve.

12. The wheel suspension according to claim 10, wherein the first supporting sleeve comprises an internal cylindrical support surface, which comprises a recess into which a sliding bushing is recessed, and in that the second supporting sleeve comprises an external cylindrical support surface, which is adapted to interact with the sliding bushing during said telescopic movement.

13. The wheel suspension according to claim 12, wherein the sliding bushing is arranged at an end of the first supporting sleeve exhibiting an opening for receiving the second supporting sleeve.

14. The wheel suspension according to claim 12, wherein the tolerances of the internal support surface and the external support surface allow a radial force transmission to take place between the supporting sleeves.

15. The wheel suspension according to claim 13, wherein the protecting and supporting means comprises a sealing, which is arranged between the supporting sleeves at the opening for preventing contaminants from penetrating in between the support surfaces.

16. The wheel suspension according to claim 10, wherein the protecting and supporting means comprises a distance sensor, which is arranged inside the first supporting sleeve or the second supporting sleeve for measuring the extension of the outer hub unit.

17. A working machine having front and rear axle assemblies, which are provided with wheel suspensions, wherein at least one of the wheel suspensions comprising:
a drive axle;
a wheel; and
a hub device, said hub device comprising a first hub unit, which is stationary in the axial direction of the wheel suspension and connected to said axle, and a second hub unit, which is connected to a wheel, said second hub unit being adapted to be displaced in the axial direction of the wheel suspension relative to the first hub unit for altering the axial position of the wheel relative to the first hub unit, wherein the hub device also comprises an actuator for controlled actuation of the second hub unit to bring about said displacement, wherein the actuator comprises a hydraulic cylinder, which is arranged inside a protecting and supporting means for absorbing forces or force components in the radial direction of the hydraulic cylinder, said protecting and supporting means comprising a first supporting sleeve, which is adapted to be connected to the chassis, and a second supporting sleeve, which is directly or indirectly connected to the second hub unit, said supporting sleeves being telescopically arranged within each other for enabling a telescopic movement between the supporting sleeves.

18. The working machine according to claim 17, wherein both axle assemblies are provided with said wheel suspensions and the working machine is at least intermittently track-bound.
